(19) United States
(12) Patent Application Publication
(10) Pub. No.: US 2017/0152342 A1
(43) Pub. Date: Jun. 1, 2017

(54) METHOD FOR THE CONTINUOUS PRODUCTION OF STABLE PREPOLYMERS

(71) Applicant: Covestro Deutschland AG, Leverkusen (DE)

(72) Inventors: Josef Sanders, Leverkusen (DE); Andreas Hecking, Langenfeld (DE); Gerrit Woudenberg, Leverkusen (DE); Sigurd Buchholz, Köln (DE); Christian Joachim Hahn, Leverkusen (DE); Ursula Tracht, Leverkusen (DE)

(21) Appl. No.: 15/316,257

(22) PCT Filed: Jun. 3, 2015
(86) PCT No.: PCT/EP2015/062442

§ 371 Date: Dec. 5, 2016

(30) Foreign Application Priority Data
Jun. 6, 2014 (EP) 14171485.7
Aug. 5, 2014 (EP) 14179900.7

(51) Int. Cl. C08G 18/10; C08G 18/42; C08G 18/66; C08G 18/34; C08G 18/32; C08G 18/76; C08G 18/48

(52) U.S. Cl. CPC C08G 18/10; C08G 18/7678; C08G 18/4277; C08G 18/4854; C08G 18/341; C08G 18/3206; C08G 18/6674; C08G 18/664

(57) ABSTRACT

The invention relates to a method for the continuous production of stable prepolymers based on high-melting diisocyanates, in particular, 1,5-naphthalindiisocyanate, and to the use thereof for producing polyurethane elastomers, in particular casting elastomers.

### CROSS-REFERENCE TO RELATED APPLICATION

This application is a national stage application (under 35 U.S.C. §371) of PCT/EP2015/062442, filed Jun. 3, 2015, which claims benefit of European Application No. 14171485.7, filed Jun. 6, 2014 and European Application No. 14179900.7, filed Aug. 5, 2014, all of which are incorporated herein by reference in their entirety.

### FIELD OF THE INVENTION

The invention relates to a process for continuously preparing stable polymers based on high-melting diisocyanates, especially on naphthalene 1,5-diisocyanate, and to the use thereof for production of polyurethane elastomers, especially cast elastomers.

### BACKGROUND OF THE INVENTION

Cast polyurethane elastomers are used on a large scale in industry. They are usually used for production of cellular or solid moldings. They are typically produced by reacting an isocyanate component with a component containing hydrogen atoms that are reactive toward isocyanates groups. The latter component usually comprises polyfunctional alcohols, amines and/or water.

For the production of cast polyurethane elastomers, there are in principle two process technology options which differ by the sequence of addition of the co-reactants. In what is called the one-shot method, the components, after being metered in by gravimetric or volumetric means, are all mixed simultaneously and reacted in shape. However, a disadvantage here is that only inferior elastomers are obtained particularly when high-melting isocyanates are used, since intermediates formed from short-chain polyol (chain extender) and isocyanate precipitate out of the reaction melt in some cases, and are thus made unavailable for further reaction and prevent the ordered further increase in molecular weight. A further disadvantage of the one-shot method is the rapid release of high heat of reaction, which can frequently be removed only inadequately. The resulting high reaction temperatures promote side reactions such as isocyanurate formation or carbodiimidization, which further impairs the elastomer properties.

For production of cast elastomers, the prepolymer method has therefore become established in industry, in which a long-chain diol component is first reacted with excess diisocyanate to give a liquid NCO prepolymer which is then subsequently reacted with a short-chain diol, for example butane-1,4-diol, or amines such as methylenebis(o-chloro-aniline) (MOCA) or diethyltoluenediamine (DETDA) and/or water. This has the advantage that a portion of the heat of reaction can already be removed without any problem even prior to the prepolymerization, and hence the exothermicity in the actual addition polymerization is lower. This promotes a regular increase in molecular weight and enables longer casting times, which makes it much easier to fill even complex molds without bubbles.

Long-chain diol components used are polyethers, polycarbonate and preferably polyesters, more preferably poly-ε-caprolactone. Isocyanate components used are tolylene diisocyanate (TDI) and methylene diphenyl diisocyanate (MDI) as pure isomer or as isomer mixture. Particularly high-quality cast elastomers are obtained with high-melting diisocyanates such as p-phenylene diisocyanate (PPDI), 3,3′-dimethyl-4,4′-biphenyl diisocyanate (TODI) and especially naphthalene 1,5-diisocyanate (NDI). Cast NDI elastomers based on polyesters, preferably poly-ε-caprolactones, and chain extenders are marketed, for example, under VULKOLLAN by Covestro.

NDI elastomers of this kind are also prepared via the prepolymer method. Since the prepolymers, however, have to be in homogeneous liquid form on reaction with the chain extenders, this is not unproblematic here, since the standard NDI prepolymers having suitable NCO contents always still contain several percent of free NDI monomer which, because of its high melting point of 127° C., already crystallizes very quickly even at temperatures well above 100° C. Since, on the other hand, prolonged storage of the NDI prepolymers leads to a prohibitively high rise in viscosity because of an increase in molecular weight resulting from allophanate formation even within a short time at temperatures above 80° C., the NDI prepolymers typically always have to be processed very quickly.

EP-A-1 918 315 describes a process for preparing NCO prepolymers based on high-melting diisocyanates, especially NDI, by which stable, i.e. homogeneously liquid, prepolymers having NCO contents of 2.5% to 6.0% and monomer contents of 1.0% to 5.0% are obtainable even at low temperatures, in which polyols such as polyester diols, poly-ε-caprolactone diols, polycarbonate diols and polyether diols having molar masses of 1000 to 3000 g/mol and viscosities of <700 mPas/75° C. are reacted with the diisocyanate at temperatures of 80-240° C. in the presence of additives. It is essential here that the reaction mixture is cooled quickly immediately after the reaction has ended. NDI is also used hereinafter as a representative synonym for other high-melting diisocyanates such as PPDI and TODI.

NCO prepolymers based on TDI and MDI and polyols are typically prepared by initially charging the entire amount of liquid, if necessary molten, isocyanate and metering in the polyol under temperature control. This ensures that an excess of NCO groups is present over the entire course of the reaction, which substantially prevents premature extension of the polyol with a corresponding increase in molar mass and viscosity. However, this process cannot be employed in the case of prepolymers based on high-melting diisocyanates. For example, the reaction in the case of use of NDI prepolymers would have to take place above the melting point of NDI, i.e. above 127° C., but side reactions take place to a considerable degree at that temperature and lead to an increase in molar mass, viscosity and functionality.

EP-A-1 918 315 therefore proposes a batchwise method for preparation of NDI prepolymers, in which the polyol is initially charged at 120 to 135° C. and the NDI is added in solid form in one portion. The NDI goes partly into solution or melts and reacts with the diol.

As well as the metered addition of solid NDI, which is inconvenient in terms of process technology and occupational hygiene, the method described still has further serious disadvantages. Since an excess of OH groups is initially present in the liquid phase, but only NCO groups are present at the end, the reaction runs through what is called the equivalence point where an equal number of OH and isocyanate groups are present. This unfavorable state has to be passed through very quickly since there is otherwise an uncontrolled increase in molecular weight and viscosity. This requires demanding temperature control. First of all, good heating is necessary in order to introduce the energy for the rapid melting of the NDI, but cooling is necessary again shortly thereafter in order that the temperature does not rise significantly above 127° C. as a result of the heat of reaction. Since the side reactions described are already running to a considerable degree at this temperature, the reaction mixture has to be cooled down quickly immediately after the reaction has ended, i.e. shortly after attainment of the clear point.

Because of the increasing inertness with respect to changes in temperature, the control of the reaction becomes more difficult with increasing batch size, which is indeed conceded in EP-A-1 918 315. The reaction is accordingly scalable only to a very limited degree. Above batch sizes of about 500 kg, it becomes very difficult to avoid the side reactions described. A further disadvantage of this inverse prepolymer method is the changeover of functionality from OH to NCO with every new batch. Emptying leaves the reactor wetted with NCO-functional prepolymer. If the reactor is not cleaned prior to the initial charging of the polyol for the next batch, for example by rinsing with solvents, a urethane layer forms on the inner walls of the reactor. This layer becomes ever thicker as the number of batches increases and makes heat transfer difficult, such that exact temperature control, which is critical for this method, already becomes impossible at an early stage. The reaction then has to be subjected to costly and inconvenient cleaning.

EP-A-1 918 315 therefore also claims a continuous process for preparing NCO prepolymers based on high-melting diisocyanates, especially NDI. What is disclosed is a process using reaction extruders in which a mixture of the polyols already described for the batchwise method and solid aromatic diisocyanate, especially NDI, is heated to at least 180 to 240° C. in one of the first zones of the extruder and is cooled down quickly to temperatures of <100° C. in downstream zones of the extruder with degassing by application of gentle vacuum. The polyols used for this purpose are heated to higher temperatures prior to use. For this purpose, polyesters are stored at 100 to 140° C., polyethers at 80 to 120° C. No other continuous reactors are mentioned.

This continuous process also has disadvantages. As in the batchwise process disclosed, the metered addition of solid NDI here too is inconvenient in terms of process technology and occupational hygiene. At temperatures above 180° C., there is the risk that the above-described quality-critical side reactions will already proceed to an imperceptible degree. Another disadvantage is the very high procurement and maintenance costs for extruders and the high cleaning complexity associated therewith, which impairs the economic viability of the process.

There is therefore still a great need for a simple and inexpensive process for preparing NDI prepolymers which avoids the described disadvantages of the prior art processes.

### SUMMARY OF THE INVENTION

It has now been found that, surprisingly, NCO prepolymers based on high-melting diisocyanates, especially on NDI, can be prepared in a simple and inexpensive manner in good quality by reacting liquid polyols with molten diisocyanates in a tubular reactor.

It is understood that the invention disclosed and described in this specification is not limited to the embodiments summarized in this Summary

### BRIEF DESCRIPTION OF THE FIGURES

The present invention will now be described for purposes of illustration and not limitation in conjunction with the figure, wherein:

FIG. 1 shows a simplified plant scheme.

### DETAILED DESCRIPTION OF THE INVENTION

The present invention provides a process for preparing NCO prepolymers based on diisocyanates having a melting point of >70° C., wherein the prepolymers have NCO contents of 2.5% to 6.0% by weight and viscosities of 800 to 5000 mPas/100° C., characterized in that
a) a liquid diisocyanate having a melting point of >70° C. or a mixture of such diisocyanates
   is reacted continuously in a tubular reactor with
b) one or more polyols having mean molar masses of 1000 to 3000 g/mol, viscosities of <700 mPas/75° C. and a functionality of 1.95 to 2.15, from the group consisting of polyether, polycarbonate and polyester,
   optionally in the presence of
c) additives such as catalysts, emulsifiers and preferably stabilizers,
   at temperatures of 80 to 175° C., optionally after prior mixing in a mixing unit, the diisocyanate already having been in the liquid form prior to contact with the polyol(s),

and the maximum reaction temperature being not higher than 60 K above the melting temperature of the diisocyanate and the reaction mixture subsequently being cooled down to <100° C. within a period of up to 10 min

The present invention also provides the prepolymers preparable by the process of the invention.

The present invention also provides for the use of the prepolymers of the invention for production of polyurethane elastomers, preferably cast elastomers, by known methods, for example by reaction with chain extenders.

The functionality of 1.95 to 2.15 mentioned above for the polyol(s) b) should be regarded in the context of the present invention as the mean functionality of the polyol(s) being used.

In the process of the invention, high-melting diisocyanates used, i.e. diisocyanates having a melting point of >70° C., may, for example, be p-phenylene diisocyanate (PPDI), 3,3′-dimethyl-4,4′-biphenyl diisocyanate (TODI), naphthalene 1,5-diisocyanate (NDI) or mixtures of these diisocyanates. Preference is given to the use of naphthalene 1,5-diisocyanate (NDI).

It is possible to use polyols having 2 or more OH groups in the process of the invention. Preference is given to diols.

The group of polyols to be used includes polyethers, polycarbonates and polyesters, polyesters being usable with preference.

Suitable polyethers are polyoxyalkylene oxides started from hydroxyl compounds, for example polypropylene oxides. Preference is given to linear polyoxytetramethylene glycols which are obtained by ring-opening polymerization of tetrahydrofuran.

Suitable polycarbonates are linear carbonates having hydroxyl end groups containing a statistical average of at least 3 carbonate groups. They are prepared, for example, by condensation of diols with phosgene, dimethyl carbonate or diphenyl carbonate.

Suitable polyesters are hydroxy-functional condensation products formed from dicarboxylic acids, preferably adipic acid or succinic acid, and excess polyfunctional alcohols, preferably ethylene glycol, butane-1,4-diol, neopentyl glycol and butane-1,6-diol. Preference is given to poly-ε-caprolactones. These are prepared by ring-opening polymerization of ε-caprolactone using difunctional starter molecules, preferably aliphatic diols, and/or water.

In a further preferred embodiment, polyesters, preferably poly-ε-caprolactones, are used in b). In this case, the one or more polyols b) used are polyesters, preferably poly-ε-caprolactones.

Suitable additives are catalysts, emulsifiers, UV and hydrolysis stabilizers, and preferably stabilizers that are typically used in polyurethane chemistry. An overview can be found, for example, in “Kunststoff Handbuch [Polymer Handbook] vol 7, ed. G. Örtel, 1983, Carl Hanser Verlag, Munich, Vienna”.

Examples for catalysts are trialkylamines, diazabicyclooctane, dibutyltin dilaurate, N-alkylmorpholines, lead octoate, zinc octoate, calcium octoate and magnesium octoate and the corresponding naphthenates, p-nitrophenoxides etc.

Examples of suitable UV and hydrolysis stabilizers are 2,6-di-tert-butyl-4-methylphenol and carbodiimides.

Examples of suitable stabilizers are Brønsted and Lewis acids, for instance hydrochloric acid, benzoyl chloride, dibutyl phosphate, adipic acid, malic acid, succinic acid, pyruvic acid, citric acid etc., and also alkyl- and arylsulfonic acids such as p-toluenesulfonic acid and preferably dodecylbenzenesulfonic acid. The stabilizers are generally used in an amount of 5 to 2000 ppm by weight, preferably 20 to 1000 ppm by weight, most preferably 50 to 500 ppm by weight, based on the amount of the polyol used.

In a further preferred embodiment of the process of the invention, for preparation of NCO prepolymers based on diisocyanates having a melting point of >70° C., the prepolymers having NCO contents of 2.5% to 6.0% by weight and viscosities of 800 to 5000 mPas/100° C.,
a) a liquid diisocyanate having a melting point of >70° C. or a mixture of such diisocyanates
   is reacted continuously in a tubular reactor with
b) one or more polyols having mean molar masses of 1000 to 3000 g/mol, viscosities of <700 mPas/75° C. and a functionality of 1.95 to 2.15, from the group consisting of polyether, polycarbonate and polyester,
   in the presence of
c1) stabilizers
   and optionally in the presence of
c2) additives such as catalysts and emulsifiers,
   at temperatures of 80 to 175° C., optionally after prior mixing in a mixing unit, the diisocyanate already having been in the liquid form prior to contact with the polyol(s),

and the maximum reaction temperature being not higher than 60 K, preferably not higher than 30 K, above the melting temperature of the diisocyanate and the reaction mixture subsequently being cooled down to <100° C. within a period of up to 10 min.

For performance of the process of the invention, separate streams of the starting isocyanate and polyol components are metered into a tubular reactor in liquid form. In this case, the ratio of the streams is such that the isocyanate component is present in such an excess that the calculated (theoretical) NCO content is in the range from 2.5% to 6.0%, preferably 3.0% to 5.0%. The temperature of the isocyanate stream is above the melting point of isocyanate, whereas the temperature chosen for the polyol stream is sufficiently high that the resulting mixing temperature is sufficiently high to prevent crystallization of the isocyanate.

Any auxiliary streams to be used may be metered in either in dissolved form in one or both of the reactant streams or as a separate stream dissolved in one of the two starting components. Preference is given to the additional use of dodecylbenzenesulfonic acid, which is metered in either in dissolved form in isocyanate component or preferably in dissolved form in the polyol component.

Depending on the mixing capacity of the tubular reactor, it may be advantageous to mix the reactant streams in a suitable mixing unit prior to entry into the reactor. Suitable units are dynamic mixing units, for example barb mixers, or preferably static mixing units, for example smooth jet nozzles or more preferably static mixers.

Suitable tubular reactors are temperature-controllable tubular reactors, i.e. tubular reactors that can be heated or cooled by closed-loop control and may contain internals for good mixing of the reactant streams and better removal of heat. Preference is given to tubular reactors of the mixer-heat exchanger type which comprise a tube bundle through which temperature control medium flows, in addition to the mixing elements in the flow tube. For a given reactant input, even in the case of a laminar flow profile, these produce such good mixing that they can be regarded as quasi-turbulent over the overall length of the tube. In this way, cross-mixing and surface renewal are controlled by flow technology and backmixing, which would lead to a molar mass distribution of unwanted breadth, is effectively reduced to a minimum. Particular preference is given to reactors having static mixing elements of the SMX type combined with inner tubes through which the temperature control medium flows.

In a preferred embodiment, the continuous reaction in the tubular reactor is effected within the pressure range of ≦30 bar, preferably ≦10 bar, more preferably in the range of ≦4 bar.

The temperature of the tubular reactor is controlled such that the temperature of the reaction mixture in the reactor is 80 to 175° C., but not higher than 60 K, preferably 30 K, above the melting temperature of the diisocyanate. It may be advantageous here to use a reactor having zones that can be kept at different controlled temperatures, or preferably a plurality of reactors kept at different controlled temperatures. This allows lowering of the reaction temperature with advancing reaction to temperatures below the melting point of isocyanate, the initial residence time above the melting temperature of the diisocyanate being such that crystallization of as yet unconverted diisocyanate is prevented. This can reduce the extent of the above-described side reactions to a minimum level. In the case of NDI, it is preferable, for example, to lower the initial reaction temperature of 130 to 150° C. after a residence time of 3 to 15 min, preferably 5 to 10 min, to 100 to 120° C.

The reaction time, i.e. the residence time in the reactor or the total residence time in the reactors, should be chosen such that the OH groups are very substantially converted, i.e. a conversion level of at least 99%, preferably 99.5% is obtained, or the NCO content of the NCO prepolymer is within a range of ±0.3% of the calculated theoretical NCO content of the prepolymer. Subsequently, the reaction mixture is cooled down to temperatures of <100° C., preferably <80° C., within a period of up to 10 min, preferably of 2 to 5 min. Suitable apparatuses for the cooling step are, for example, heat exchangers or preferably temperature-controllable static mixers. The cooling is preferably continuous.

The course of the reaction is advantageously followed by means of various measuring units. Suitable units for this purpose are especially units for measurement of temperature, viscosity, refractive index and/or thermal conductivity in flowing media and/or for measurement of infrared and/or near infrared spectra.

For production of cast elastomers, the NCO prepolymers prepared by the process of the invention are reacted with one or more chain extenders at relatively high temperatures. The production of cast elastomers is well known to those skilled in the art and is described in detail, for example, in “Kunststoff Handbuch vol. 7, ed. G. Örtel, 1983, Carl Hanser Verlag, Munich, Vienna”. There are also examples of suitable chain extenders therein. Preference is given to linear α,ω-diols having 2 to 12 carbon atoms such as butane-1,4-diol or hexane-1,6-diol, aromatic diamines, for example methylenebis(o-chloroaniline) (MOCA) or diethyl-toluenediamine (DETDA) and/or water. For production of the cast elastomers, it is also possible to use the additives already mentioned above, such as catalysts, emulsifiers and stabilizers.

The NCO prepolymers prepared by the process of the invention have NCO contents of 2.5% to 6.0% by weight, preferably 3.0% to 5.0% by weight, and viscosities of 800 to 5000 mPas/100° C., preferably 1000 to 2500 mPas/100° C., and can advantageously be used for production of solid or else cellular elastomers.

### EXAMPLES

The comparative examples and inventive examples which follow are intended to illustrate the invention, but without restricting it.

All amounts stated, unless noted otherwise, are based on mass. All reactions, unless stated otherwise, were conducted under a nitrogen atmosphere.

Production and Properties of NCO Prepolymers

Analysis Methods

The NCO content of the prepolymers described in the inventive examples and comparative examples was determined by titration according to DIN EN ISO 11 909.

The dynamic viscosities were determined at the particular temperature with the HAAKE VT 550 viscometer. By measurements at different shear rates, it was ensured that the flow characteristics of the NCO prepolymers of the invention described correspond to ideal Newtonian liquids. There is therefore no need to state the shear rate.

Raw Materials

TERETHANE 2000: polytetramethylene ether glycol from INVISTA having a molecular weight of 2000 Da and an OH functionality of 2.

DESMOPHEN 2001 KS: ethylene glycol-butane-1,4-diol adipate from Covestro having a molecular weight of 2000 Da and an OH functionality of 2.

CAPA 2161A: poly-ε-caprolactone from PERSTORP having a molecular weight of 1600 Da and an OH functionality of 2.

DESMODUR 15: naphthalene 1,5-diisocyanate from Covestro.

DESMODUR 15 S37: prepolymer from Covestro based on CAPA 2161A and DESMODUR 15, prepared in a batchwise process as described in EP-A-1 918 315.

Dodecylbenzenesulfonic acid: from Aldrich.

1,2,4-Trichlorobenzene: from Aldrich.

Description of Plant

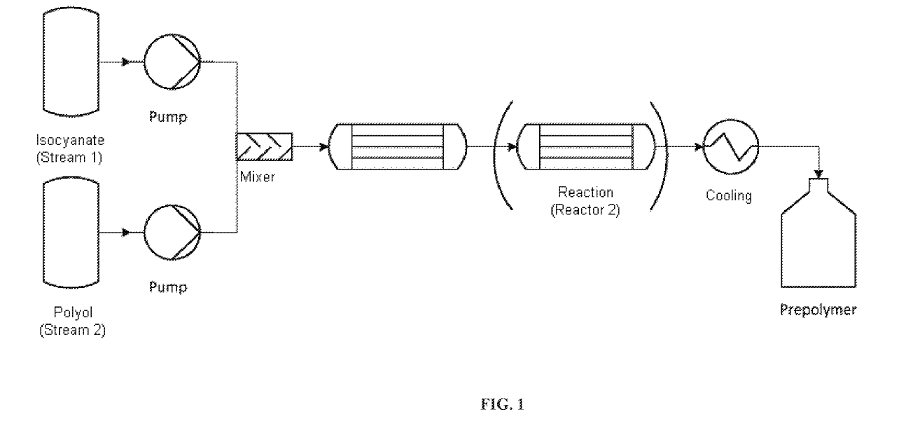

The NCO prepolymers are prepared using a miniplant (FIG. 1) consisting of heated reactant reservoirs for isocyanate (Stream 1) and polyol (Stream 2), two pumps for the reactants, a mixer, one or two tubular reactors of the mixer-heat exchanger type, a product cooler and a product receiver. The initial charge of isocyanate is heated to 150° C. and the initial charge of polyol to 80° C., the initial charge of polyol containing 250 ppm by weight (based on the amount of the polyol used) of dodecylbenzenesulfonic acid. The isocyanate conduit to the delivery pump and thence to the mixer is heated to 150° C., whereas the analogous polyol conduits and the mixer are heated to 130° C. Preliminary mixing is accomplished using a micro cascade mixer from Ehrfeld Mikrotechnik BTS (Wendelsheim, Germany). In one-reactor mode, a reactor (DN20) having a capacity of 118 mL heated to 130° C. is used. In two-reactor mode, the first reactor (DN20) has a capacity of 58 mL and is heated to 130° C., whereas the second reactor (DN20) has a capacity of 118 mL and is heated to 110° C. The cooler used is a jacketed tube which is heated to 80° C. Both the reactant reservoirs and the product receiver are blanketed with dry nitrogen.

Experimental Procedure

Prior to commencement of the experiments, all parts of the plant and the reactants are preheated. To start the reaction plant, the entire plant is rinsed with 1,2,4-trichlorobenzene (TCB). The flow rates are set in accordance with the desired residence time and the NCO:OH ratio. First Stream 1 is switched to the reactor and then, 2 min later, Stream 2 is switched on. The first portion of product is at first run into the waste. After about 3 residence times, the quality is stable and the product is run into the product receiver.

In regular operation, the plant runs with defined flow rates and a defined temperature profile.

To stop the plant, first of all, Stream 2 is switched to TCB with retention of the flow rate and, 2 min later, Stream 1 is also switched to TCB. The plant is rinsed with solvent for a further period.

The reaction parameters and properties of the prepolymers thus prepared are compiled in Table 1. DESMODUR 15 S37 is a commercial prepolymer from batchwise production provided for comparison.

TABLE 1

| | | | | | Target | Actual | Viscosity |
|---|---|---|---|---|---|---|---|
| | | RT | Reactor | | NCO | NCO | at 100° C. |
| Prepolymer | NCO:OH | [min] | config. | Polyol | [%] | [%] | [mPas] |
| 1 | 1.80 | 20 | 1 | CAPA 2161A | 3.40 | | |
| 2 | 1.94 | 20 | 2 | CAPA 2161A | 3.93 | 4.54 | 1220 |
| 3 | 1.80 | 20 | 2 | CAPA 2161A | 3.40 | 4.15 | 1375 |
| 4 | 1.94 | 25 | 2 | CAPA 2161A | 3.93 | 4.61 | 1325 |
| 5 | 1.80 | 25 | 2 | CAPA 2161A | 3.40 | 4.16 | 1535 |
| 6 | 1.94 | 20 | 2 | TERETHANE | 3.28 | 3.80 | 1900 |
| | | | | 2000 | | | |
| 7 | 1.94 | 25 | 2 | DESMOPHEN | 3.28 | 3.78 | 2740 |
| | | | | 2001 KS | | | |
| 8 | 1.70 | 15 | 2 | CAPA 2161A | 3.01 | 3.48 | 2300 |
| 9 | 1.70 | 20 | 2 | CAPA 2161A | 3.01 | 3.42 | 2350 |
| DESMODUR | 1.94 | | Batch | CAPA 2161A | 3.93 | 3.90 ± 0.3 | 2000 |
| 15 S37 | | | | | | | |

By means of the pumps, the reactants are first guided into a mixer and premixed therein, and then converted to the prepolymer in one or two successive reactors. Subsequently, the prepolymer is cooled down to <80° C. in a downstream condenser and then collected.

Production of the Cast Elastomers

600 g of the prepolymers listed are degassed at about 20 mbar and 90° C. by stirring under reduced pressure for 15 minutes, and 21.6 g of butane-1,4-diol are added at this temperature. Subsequently, the mixture is homogenized in a SPEEDMIXER at 1800 rpm for 30 s and poured into a folding mold preheated to 110° C. with layer thickness 12 mm. The casting and solidification times are determined on a workbench at 110° C. The filled molds are first heated at 110° C. for 24 h. After demolding, the specimens are stored at room temperature for 4 weeks and then characterized.

Test Conditions

Shore A hardness testing in accordance with DIN ISO 7619-1

Test conditions: 23° C., 52% relative humidity Measurement duration: 3 sec., sample height 6 mm, sample size 45 mm (diameter), test instrument: TM000653

strength/elongation at break=tensile test in accordance with DIN 53504/ISO 37

Test conditions: 23° C., 52% relative humidity Load cell: TM000536, displacement transducer: TM000669, testing speed: 500 mm/min sample width: 6 mm, specimen: 51 dumbbell, test machine: TM000644, initial force: 1 N

Tear propagation resistance in accordance with DIN ISO 34-1

Test conditions: 23° C., 52% relative humidity Load cell: TM000536, displacement transducer: TM000644, test specimen: Graves, testing speed: 500 mm/min.

Abrasion in accordance with DIN ISO 4649-A

Test conditions: 23° C., 52% relative humidity Test machine: TM000671

Compression set (CS) in accordance with DIN ISO 815-1 (elastomers), test procedure TM900004,

Specimen: type B 13 mm (cross section), room temperature: 23° C., conditioning >3 hours, recovery phase 30 min. Thickness calipers: upper measurement surface 4.0 mm, test system: TM900004

The properties of the elastomers thus produced from the prepolymers are compiled in Table 2. DESMODUR 15 S37 is a commercial prepolymer from batchwise production provided for comparison.

TABLE 2

| | | | Shore | Tensile | | Tear | | CS |
|---|---|---|---|---|---|---|---|---|
| | Casting | Solid- | (4 wks./ | strength | Elongation | propagation | | (70 h/ |
| | time | ification | RT) | (break) | at break | resistance | Abrasion | 23° C.) |
| Prepolymer | [sec] | [min] | [A] | [N/mm²] | [%] | [kN/m] | [mg] | [%] |
| 1 | 190 | 14 | 93 | 44.32 | 481 | 42 | 50 | 16.2 |
| 2 | 225 | 19 | 95 | 42.29 | 465 | 76 | 45 | 11.8 |
| 3 | 240 | 16 | 95 | 48.18 | 553 | 77 | 44 | 16.4 |
| 4 | 245 | 15 | 94 | 45.15 | 470 | 82 | 45 | 12.4 |
| 5 | 245 | 20 | 94 | 42.29 | 492 | 43 | 46 | 11.1 |
| 6 | 200 | 13 | 93 | 17.79 | 419 | 30 | 38 | 18.8 |
| 7 | 90-270 | 19 | 90 | 41.91 | 643 | 46 | 50 | 10.1 |
| 8 | 300 | 16 | | 39.88 | 664 | 73 | 53 | 22.8 |
| 9 | 320 | 16 | | 44.25 | 623 | 68 | 53 | 20.3 |
| DESMODUR | 256 ± 20 | 13 ± 2 | 94 ± 2 | 43.89 ± 2.00 | 560 ±50 | 64 ± 10 | 44 ± 5 | 19.0 ± 3.0 |
| 15 S37 | | | | | | | | |
| Pt. 1375810 | 275 | 14 | 94 | 42.98 | 513 | 54 | 49 | 20.1 |
| Pt. 1373040 | 240 | 14 | 94 | 44.79 | 527 | 57 | 47 | 16.4 |
| Pt. 1373070 | 260 | 14 | 94 | 45.61 | 579 | 67 | 39 | 18.4 |

A comparison of the mechanical data of the elastomers shows that the prepolymers of the invention give rise to at least equivalent and in some cases even better elastomers than the commercial DESMODUR 15 S37 polymer which is prepared in a batchwise process. In the case of Prepolymer 4, for example, the tear propagation resistance at 82 kN/m, compared to 64 kN/m in the case of the commercial product, is improved by 28% because of the lower content of higher-functionality allophanates for process-related reasons. As the batch data for some DESMODUR 15 S37 batches (Pt. 1375810, 1373040 and 1373070) show, distinct variations in quality in the batchwise process are unavoidable. By contrast, the quality of the prepolymers prepared by the continuous process of the invention is much more constant for every defined setting. More particularly, these prepolymers always have lower proportions of higher-functionality allophanates than comparable prepolymers from batchwise production or from continuous production in an extruder, as described, for example, in EP-A-1 918 315.

Various aspects of the subject matter described herein are set out in the following numbered clauses:

1. A process for preparing NCO prepolymers based on diisocyanates and having a melting point of >70° C., the prepolymers having NCO contents of 2.5% to 6.0% by weight and viscosities of 800 to 5000 mPas/100° C., characterized in that a) a liquid diisocyanate having a melting point of >70° C. or a mixture of such diisocyanates is reacted continuously in a tubular reactor with b) one or more polyols having mean molar masses of 1000 to 3000 g/mol, viscosities of <700 mPas/75° C. and a functionality of 1.95 to 2.15, from the group consisting of polyether, polycarbonate and polyester, optionally in the presence of c) additives such as catalysts, emulsifiers and preferably stabilizers, at temperatures of 80 to 175° C., optionally after prior mixing in a mixing unit, the diisocyanate already having been in the liquid form prior to contact with the polyol(s), and the maximum reaction temperature being not higher than 60 K above the melting temperature of the diisocyanate and the reaction mixture subsequently being cooled down to <100° C. within a period of up to 10 min.

2. The process as in clause 1, wherein a liquid diisocyanate having a melting point of >70° C. from the group consisting of p-phenylene diisocyanate (PPDI), 3,3′-dimethyl-4,4′-biphenyl diisocyanate (TODI) and naphthalene 1,5-diisocyanate (NDI) or a mixture of these diisocyanates is used.

3. The process as in clauses 1 or 2, wherein naphthalene 1,5-diisocyanate (NDI) is used as liquid diisocyanate.

4. The process as in any of clauses 1 to 3, wherein diols are used in b).

5. The process as in any of clauses 1 to 4, wherein polyesters, preferably poly-ε-caprolactones, are used as one or more polyols b).

6. The process as in any of clauses 1 to 5, wherein the continuous reaction in the tubular reactor is effected within the pressure range of <30 bar, preferably <10 bar, more preferably in the range of <4 bar.

7. The process as in any of clauses 1 to 6, wherein the maximum reaction temperature is not higher than 30 K above the melting temperature of the diisocyanate.

8. The process as in any of clauses 1 to 7, wherein the reaction mixture is cooled down continuously.

9. The process as in any of clauses 1 to 8, wherein the components are mixed beforehand and the mixing unit used is a static mixer.

10. A prepolymer obtainable by a process as in any of clauses 1 to 9.

11. The prepolymer as in clause 10 having NCO contents of 3.0% to 5.0% by weight.

12. The prepolymer as in clause 10 or 11 having viscosities of 1000 to 2500 mPas/100° C.

13. The use of the prepolymers as in any of clauses 10 to 12 for preparation of polyurethane elastomers, preferably cast elastomers.

1. A process for preparing an NCO prepolymers comprising
continuously reacting a liquid diisocyanate having a melting point of >70° C. or a mixture of such diisocyanates in a tubular reactor with
one or more polyols having mean molar masses of 1000 to 3000 g/mol, viscosities of <700 mPas/75° C. and a functionality of 1.95 to 2.15, selected from the group consisting of polyether polyols, polycarbonate polyols and polyester polyols,
optionally in the presence of
additives such as catalysts, emulsifiers and stabilizers,
at temperatures of 80 to 175° C., optionally after prior mixing in a mixing unit, the diisocyanate already having been in the liquid form prior to contact with the polyol(s), and the maximum reaction temperature being not higher than 60 K above the melting temperature of the diisocyanate and the reaction mixture subsequently being cooled down to <100° C. within a period of up to 10 min,
wherein the diisocyanate has a melting point of >70° C., and wherein the prepolymer has an NCO content of 2.5% to 6.0% by weight and a viscosity of 800 to 5000 mPas/100° C.

2. The process according to claim 1, wherein a the liquid diisocyanate having a melting point of >70° C. is selected from the group consisting of p-phenylene diisocyanate (PPDI), 3,3′-dimethyl-4,4′-biphenyl diisocyanate (TODI) and naphthalene 1,5-diisocyanate (NDI) and a mixture of these diisocyanates.

3. The process as according to claim 1, wherein the liquid diisocyanate is naphthalene 1,5-diisocyanate (NDI).

4. The process according to claim 1, wherein the polyols are diols.

5. The process according to claim 1, wherein the polyols are polyesters.

6. The process according to claim 1, wherein the continuous reaction in the tubular reactor is effected within the pressure range of ≦30 bar.

7. The process according to claim 1, wherein the maximum reaction temperature is not higher than 30 K above the melting temperature of the diisocyanate.

8. The process according to claim 1, wherein the reaction mixture is cooled down continuously.

9. The process according to claim 1, wherein the components are mixed beforehand and the mixing unit used is a static mixer.

10. A prepolymer obtainable by the process as claimed in claim 1.

11. The prepolymer according to claim 10 having NCO contents of 3.0% to 5.0% by weight.

12. The prepolymer according to claim 10 having viscosities of 1000 to 2500 mPas/100° C.

13. In a process for the preparation of polyurethane elastomers, the improvement comprising including the prepolymer according to claim 10.

14. The process according to claim 1, wherein the continuous reaction in the tubular reactor is effected within the pressure range of ≦10 bar.

15. The process according to claim 1, wherein the continuous reaction in the tubular reactor is effected within the pressure range of ≦4 bar.

16. In a process for the production of cast elastomers, the improvement comprising including the prepolymer according to claim 10.

17. The process according to claim 1, wherein the polyols are poly-ε-caprolactones.
